(19) United States
(12) Patent Application Publication
(10) Pub. No.: US 2026/0289406 A1
(43) Pub. Date: Sep. 24, 2026

(54) METHODS AND SYSTEMS FOR PRIVACY-PRESERVING FEDERATED LEARNING FOR RELATIONAL DATA

(71) Applicants: STACY PATTERSON, Troy, NY (US); MD SAIKAT ISLAM KHAN BAPPY, Troy, NY (US); OSHANI W SENEVIRATNE, Albany, NY (US); APARNA GUPTA, Latham, NY (US); Rensselaer Polytechnic Institute, Troy, NY (US)

(72) Inventors: STACY PATTERSON, Troy, NY (US); MD SAIKAT ISLAM KHAN BAPPY, Troy, NY (US); OSHANI W SENEVIRATNE, Albany, NY (US); APARNA GUPTA, Latham, NY (US)

(73) Assignee: Rensselaer Polytechnic Institute, Troy, NY (US)

(21) Appl. No.: 19/563,865

(22) Filed: Mar. 11, 2026

Related U.S. Application Data
(60) Provisional application No. 63/769,969, filed on Mar. 11, 2025.
(60) Provisional application No. 64/001,844, filed on Mar. 10, 2026.

(51) Int. Cl. G06N 20/00

(52) U.S. Cl. CPC G06N 20/00

(57) ABSTRACT

Methods, systems, and software for training models configured to detect exceptional data in one or more databases among a plurality of databases including vertical and horizontal partitioning in which the risk of privacy leakage is reduced. Measures are included in some embodiments to protect data record embeddings, sensitive data labels, and descent steps during sharing of information between owners of databases relevant to the model training.

### CROSS-REFERENCE TO RELATED APPLICATIONS

This application claims priority to U.S. Provisional Patent Application No. 63/769,969, filed Mar. 11, 2025 and U.S. Provisional Patent Application No. 64/001,844, filed Mar. 10, 2026, the disclosures of which are hereby incorporated by reference in their entireties.

### BACKGROUND

Federated learning (FL), a distributed machine learning (ML) paradigm where parties jointly train a global model without directly sharing raw data, has previously been employed as a way to utilize ML to detect anomalous data (e.g., in financial data) while restricting the leakage of confidential data that could occur through data sharing. However, traditional FL approaches still face privacy vulnerabilities, as information can be leaked through intermediate updates such as model gradients. Additionally, protecting labels, which may contain sensitive information (e.g. fraud status in the realm of financial data), has become an additional aspect of privacy-preserving FL.

While existing privacy-preserving methods exist, they often face challenges such as high computational overheads or reduced accuracy. Approaches relying heavily on cryptographic methods like homomorphic encryption can impose substantial computational overhead, making them impractical for real-time fraud detection systems that must process millions of transactions daily. Beyond this general need for privacy and computational efficiency, FL faces a more fundamental challenge in how real-world data is structured. More importantly, the majority of FL methods assume that training data is partitioned in one of two standard ways: horizontally, where parties share the same feature space, or vertically, where each party has a distinct feature space for the same set of sample IDs. However, these assumptions do not hold in complex real-world scenarios such as financial crime detection, where data exhibits a many-to-many relational structure. In financial systems, transaction data held by one party (e.g., payment processors) must be linked with account information distributed across multiple parties (e.g., different banks), with each transaction involving multiple accounts and each account participating in multiple transactions. This creates a hybrid partitioning that combines elements of both horizontal and vertical partitioning while introducing complex relational dependencies that existing FL approaches cannot handle effectively. This hybrid partitioning exists in numerous other data domains: healthcare (treatments linked to patient/insurance accounts), supply chain (shipments connected to manufacturer/retailer accounts), and e-commerce (purchases linking buyer/seller accounts) are additional examples.

Thus, there is a need for privacy-preserving FL approaches designed for this relational data structure. For example, the vast amounts of data collected on financial customers and transactions provide a rich source of information to construct ML models that can detect anomalous financial transactions connected to illicit activity. Although various ML techniques for financial fraud detection have been explored, they rely on centralized methods where all data management and training processes are consolidated into a central hub. This centralization poses serious threats to the confidentiality of participant data and may lead to potential privacy breaches. Such vulnerabilities can have particularly adverse effects in domains like finance, where maintaining the privacy of various parties is imperative, and financial organizations might be reluctant to share their data due to regulatory constraints and concerns about losing competitive advantage. These conflicting demands present a challenge in striking a balance between facilitating adequate utilization of ML methodologies for detecting anomalous financial behavior and restricting the leakage of confidential data that could occur through data sharing.

### SUMMARY

According to a first aspect of the present technology, a method for training a model configured to detect exceptional or data in one or more databases among a plurality of databases having related data and that have vertical and horizontal partitioning while preserving privacy in the training data is provided. In some embodiments, differential privacy, secure multi-party computation, and/or a randomized response mechanism are employed to protect sensitive data.

In a second aspect of the present technology, an algorithm is provided for training a model configured to detect exceptional or data in one or more databases among a plurality of databases is implemented as software instructions on a non-transitory, computer-readable medium.

In another aspect of the technology, a computer system for training a model configured to detect exceptional or data in one or more databases among a plurality of databases is provided. Additional features of the technology will now be described in reference to the following figures.

### BRIEF DESCRIPTION OF THE DRAWINGS

The drawings show embodiments of the disclosed subject matter for the purpose of illustrating the technology. However, it should be understood that the present application is not limited to the precise arrangements and instrumentalities shown in the drawings, wherein:

FIG. 1 schematically illustrates an overview of the data and model partitioning addressed by some embodiments of the present technology;

FIG. 2 shows a flowchart of a method according to a first embodiment of the present technology;

### DETAILED DESCRIPTION

The following discussion relates to various embodiments of methods, systems, and software for privacy-preserving federated learning for relational data. It will be understood that the herein described versions are examples that embody certain inventive concepts as detailed herein. To that end, other variations and modifications will be readily apparent to those of sufficient skill. The terms “about” or “approximately” as may be used herein may refer to a range of 80%-120% of the claimed or disclosed value. Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

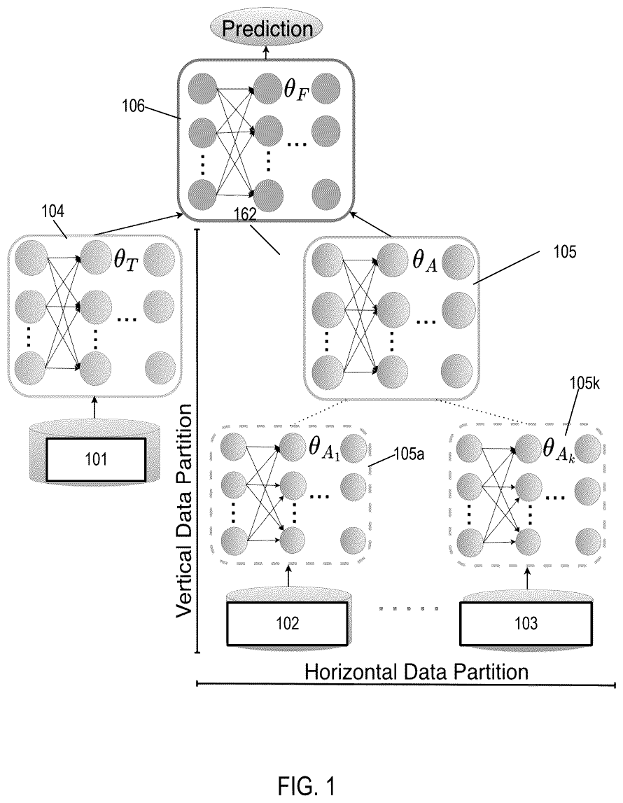

FIG. 1 shows a schematic diagram of databases and models with both vertical data partitioning and horizontal data partitioning. Such a data arrangement includes a many-to-many vertical partitioning between a first dataset 101 and second and third datasets 102, 103, respectively. In other words, each data record in the first database includes one or more values in common with data records in both of the second and third databases. FIG. 1 also shows horizontal partitioning across the second and third databases 102, 103. In some embodiments, the second and third databases are two among a plurality of databases. The present technology is not limited with respect to the upper number of databases to which it can be applied.

For example, in an embodiment in which a model is to be trained to detect anomalous financial transactions, the first database 101 contains a transaction dataset and the second and third databases contain account datasets, with one transaction record corresponding to a sender and receiver account and one account corresponding to one or more transactions. Model training data is thus partitioned between a transaction party (e.g., Swift for wire transfers, online retailers for purchases) which stores features about individual transactions, and account parties (e.g., banks, credit card companies), which hold information about the accounts involved in these transactions. In some embodiments, there are 3, 4, 5, or more “account parties” and associated databases, as will be understood by those of skill in the art.

FIG. 1 also illustrates a first embedding model 104, which is designed to generate embeddings of the data in the first database 101, and second embedding model 105, which generates embeddings for the data in second and third databases 102, 103, respectively. In some embodiments, copies 105a-105k of the second embedding model are associated with the second, third, and so on databases 102, 103, each copy of the database held and accessible by the owner of the second and third databases. As described more fully herein, the owners of the second, third, etc. databases collaborate to update the parameters of these models for generating embeddings of the data in the second, third, and so on, databases.

The model 106, in this embodiment, takes the embeddings from models 104 and 105 and generates a prediction related to exceptional data. In some embodiments, the prediction is intended to detect an anomalous transaction. Some embodiments of the present technology endeavor to train the models 104, 105, 106, while reducing the risk of privacy leakage related to the data owned by the owners of the databases. In some embodiments, the model comprises a neural network. In other embodiments, the model comprises a linear model.

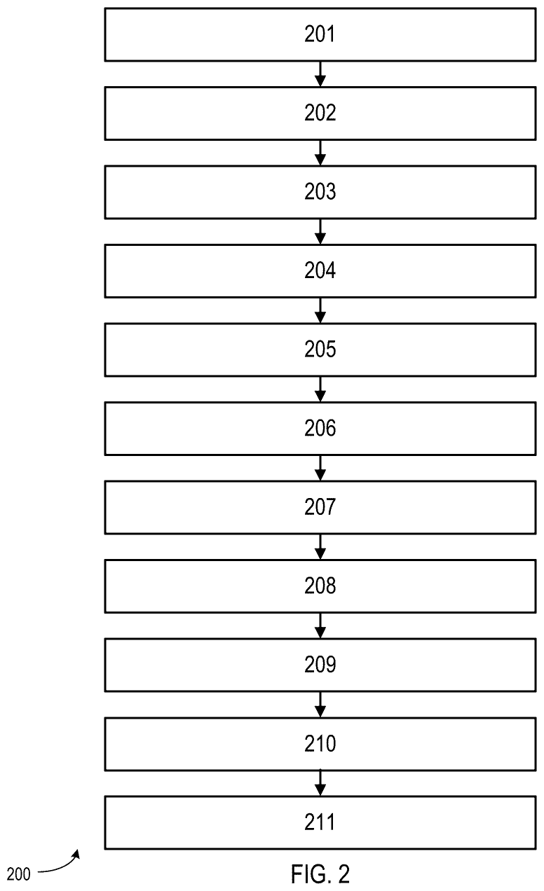

A first embodiment of a method 200 for training a model configured to detect exceptional data in one or more databases among a plurality of databases will now be described in reference to FIG. 2. Exceptional data includes data of interest to the user and which a model can be trained to detect, including, for example an anomalous financial transaction or a fraudulent transaction.

In this embodiment, the method 200 comprises generating 201, for each record of a first set of data records in a first database, an embedding to form a first set of embeddings, wherein the first set of data records includes one or more field values in common with both of a second and a third set of data records in a second and third database respectively. In other words, in this embodiment, the data records in the first database have a one-to-many relationship with the records in the second and third databases. For example, for financial transactions, each transaction record includes a field value linked to two account records: a sender account and a receiver account.

The method 200 further comprises generating 202, for each record of the second set of data records in the second database, an embedding to form a second set of embeddings, wherein the second set of data records includes one or more data records having one or more field values in common with one or more data records in the first set of data records and generating 203, for each record of the third set of data records in the third database, an embedding to form a third set of embeddings, wherein the third set of data records includes one or more data records having one or more field values in common with one or more data records in the first set of data records. Thus, in this embodiment, the data records in the second and third databases have a one-to-many relationship with the data records in the first database. For example, for financial transactions, a single account can participate in multiple transaction records.

The method 200 further comprises generating 204, for each set of embeddings, a privacy-protected dataset of the embeddings to form a first, second, and third privacy-protected dataset, respectively.

The model 200 comprises inputting 205 the first, second, and third privacy-protected datasets to the model to generate a prediction for each of the first set of data records, then computing 206 the result of a loss function with respect to the model parameters for each of the first set of data records, and then updating 207 the model parameters based on the loss calculated via a gradient step. In some embodiments, a stochastic gradient descent (SDG) or Adam optimizer algorithm is used.

The method 200 further comprises computing 208 an additional loss result with respect to parameters of a first embedding model configured to provide embeddings of the data records in the first database to the model and parameters of a second embedding model configured to provide embeddings of the data records in the second and third databases to the model. The method 200 comprises then updating 209 the first embedding model parameters based on the additional loss result via a gradient step.

The method 200 further comprises generating 210 a privacy protected additional loss result for the second embedding model; and updating 211 the second embedding model parameters based on the privacy protected additional loss result.

In some embodiments, the step of generating a privacy-protected dataset of the embeddings to form a first, second, and third privacy-protected dataset, comprises applying local differential privacy noise to each embedding. In some embodiments, Gaussian noise is added to the embeddings. In some embodiments, the step of generating a privacy-protected dataset of the embeddings to form a first, second, and third privacy-protected dataset, comprises applying differential privacy noise to each embedding; and using multi-party computation to sum the noisy embeddings. In some embodiments, a Poisson Binomial Mechanism is used to provide differential privacy and Secure Aggregation is used as the multi-party computation to compute the sum of the embeddings.

In some embodiments, each of the first set of data records comprises a sensitive label. For example, in a financial transaction embodiment, a data record may have been labeled as fraudulent in the transaction database. The owner of the transaction database may wish to keep the label confidential from the other parties involved in training and using the model 106. In some embodiments, then, the method further comprises transforming each label into a protected label using a randomized response mechanism. The embeddings that include the protected labels are then used to compute a second additional loss result with respect to parameters of the second embedding model. This second additional loss result is used to generate partial derivatives with respect to the second and third embeddings and is sent to the owners of the second and third databases. Thus, the step of generating a privacy protected additional loss result for the second embedding model comprises using the second additional loss result and the step of updating the second embedding model parameters is based on the second additional loss result.

In some embodiments, the step of computing an additional loss result comprises computing a partial derivative of the loss function for each embedding in the second set of embeddings and each embedding in the third set of embeddings. In some embodiments, the step of generating a privacy protected additional loss result for the second embedding model further comprises: computing a descent step using the partial derivatives for each embedding, quantizing the components of the descent steps using a Poisson Binomial Mechanism, and computing a component-wise sum of the quantized descent steps using multi-party computation. This sum can then be provided to one of the owners of the second or third databases and, in some embodiments, dequantizing the component-wise sum to obtain an estimated descent step and using the estimated descent step to update the second embedding model parameters. As described above, in some embodiments, updating the second embedding model parameters using the estimated descent step further comprises updating the parameters of copies of the second embedding model, each copy associated with one of the second database and the third database.

According to a second aspect of the present technology, software for training a model configured to detect exceptional data in one or more databases among a plurality of databases is provided. In one embodiment, a non-transitory computer readable medium is provided having instructions stored thereon that, when executed by a computing device, cause the computing device to perform operations as described in connection with FIG. 2 and above. In some embodiments, the software resides in one or more cloud-based systems and access and is accessed by the databases and models remotely.

According to a third aspect of the present technology, a system for training a model configured to detect exceptional data in one or more databases among a plurality of databases is provided, the system comprising one or more processors and a memory coupled to the one or more processors, the memory storing instructions that, when executed by the one or more processors, cause the system to perform operations as described in connection with FIG. 2 and above. In some embodiments, the systems according to the present technology are distributed across multiple processors, memory storage locations, and physical locations.

### Examples of Privacy Mechanisms

Differential Privacy (DP) provides theoretical privacy guarantees for datasets. Standard DP is a randomized mechanism used to generate the output of a computation, for example, computing a sum, in a manner that obfuscates whether a particular input was used to produce the computation output. Local DP is a variant of DP in which the data itself is obscured via a randomized process, providing privacy guarantees before the data is used in the computation.

In some embodiments of the present technology, Renyi Differential Privacy (RDP), a version of DP derived from the principle of Renyi divergence, is used to provide standard DP and local DP at various steps in the algorithm. RDP facilitates the computation of cumulative privacy loss over the composition of multiple randomized mechanisms. This composition provides theoretical bounds on the total privacy loss over the entire training process.

A formal definition of Renyi divergence is: For α∈(0, ∞), α≠1, the Renyi divergence of order α between two probability distributions [symbol] and [symbol] is

$${D}_{α} ( P \vert \vert Q ) {=}^{def} \frac{1}{α - 1} log ( {𝔼}_{x \sim 𝒬} [ {𝒫 ( x )}^{α} {𝒬 ( x )}^{1 - α} ] )$$

where log(·) is the natural logarithm.

Renyi Differential Privacy (RDP) means: A randomized mechanism [symbol] satisfies (α, ϵ)-RDP if for any two adjacent datasets D and D′ and any α>1, it holds that

$${D}_{α} ( M ( D ) \vert \vert M ( {D}^{′} ) ) \leq ϵ .$$

Here, adjacent means that datasets differ in exactly one record. The value of ϵ, commonly called the privacy budget, indicates the level of privacy for the dataset, with a smaller ϵ corresponding to greater privacy. Informally, RDP provides a degree of indistinguishability of whether a particular record was included in the computation of [symbol] .

Local Renyi Differential Privacy (Local RDP) means: A randomized mechanism [symbol] satisfies (α, ϵ)-Local RDP if for any two inputs x₁, x₂∈ [symbol] , where [symbol] is the input domain, it holds that

$${D}_{α} ( ℳ ( {x}_{1} ) \vert \vert ℳ ( {x}_{2} ) ) \leq ϵ .$$

In Local RDP, ϵ quantifies the privacy that a mechanism [symbol] provides when applied to a single record.

In some embodiments, Poisson Binomial Mechanism (PBM) is used to provide standard (α, ϵ)-RDP for data privacy. The mechanism ensures that only a noisy aggregate is revealed through multi-party computation (MPC, see below), thereby protecting the privacy of each party's individual contributions when computing sums of embeddings. The process for computing the sum over a set of M scalar values x₁, . . . x_{M}, with each x₁∈[−k, k], where each value is held by a different party, is briefly described. Each party first quantizes its value into one of b bins according to Algorithm 1:

Algorithm 1 Poisson Binomial Mechanism

1: function PBM (xᵢ, b, β, k)
$2 : Initialize : {x}_{i} ∈ [ - k , k ] ; b ∈ ℕ , β ∈ [ 0 , \frac{1}{4} ]$
$3 : Determine probability {p}_{i} ← \frac{1}{2} + \frac{β}{k} {x}_{i}$
4: Generate quantized value qᵢ ← BINOM ( b, pᵢ)
5: return qᵢ
6: end function

The parties use MPC to find the sum

$$\hat{q} = {\sum }_{i = 1}^{M} {q}_{1}$$

while keeping each qᵢ secret. An estimated value of the sum is then computed from

$$\hat{q} as \tilde{s} = \frac{k}{β b} ( \hat{q} - \frac{b M}{2} ) .$$

Note that the PBM injects randomization by drawing values from a binomial distribution; thus, PBM provides quantization and randomization. The parameters b and β determine the degree of privacy. It has been shown that the sum computation yields an unbiased estimate of the correct sum with variance

$$\frac{{k}^{2} M}{4 {β}^{2} b} ,$$

while providing (α, ϵ(α))-RDP with ϵ(α)=Ω(bβ²α/(M−1)).

Multiparty Computation (MPC): The privacy guarantees for standard RDP, such as the sum computation, apply when only the sum is revealed. If any of the inputs to the sum are also shared, the privacy decreases. Thus, in some embodiments, it is important to ensure they remain private during the sum computation. In some embodiments, this is achieved using MPC.

MPC is a cryptographic protocol that allows multiple parties to collaboratively compute a function over their inputs while ensuring that these inputs remain confidential. “Practical secure aggregation for federated learning on user-held data,” arXiv preprint arXiv.1611.04482, 2016 by K. Bonawitz, V. Ivanov, B. Kreuter, A. Marcedone, H. B. McMahan, S. Patel, D. Ramage, A. Segal, and K. Seth, the disclosure of which is incorporated by reference herein, provides MPC protocols that are applied in some embodiments of the present technology. One aspect of MPC protocols is that the inputs are integer values. Thus, PBM is a natural fit with MPC since it quantizes the inputs before the sum computation.

Randomized response mechanism provides local RDP by adding noise directly to individual data values before they are used in any computation. Specifically, let ƒ be a function, i.e., ƒ: [symbol] →{0,1}, where [symbol] is the input space. The randomized response mechanism for ƒ is defined as:

$${RR}_{p} ( f ( x ) ) = \{ \begin{matrix}f ( x ) & with probability p , \\ 1 - f ( x ) & with probability 1 - p .\end{matrix}$$

Here, the mechanism randomly flips the output of ƒ(x) based on the probability p. This randomization prevents an observer from reliably inferring the original value ƒ(x) from the released output, thereby protecting privacy. The mechanism provides local (α, ϵ(α))-RDP, where:

$$ϵ ( α ) = \{ \begin{matrix}\frac{1}{α - 1} log ( {{p}^{α} ( 1 - p )}^{1 - α} + {( 1 - p )}^{α} {p}^{1 - α} ) & if α > 1 , \\ ( 2 p - 1 ) log ( \frac{p}{1 - p} ) & if α = 1.\end{matrix}$$

### Example

One example embodiment involves a distributed computing system comprised of two data silos, such as that shown in FIG. 1. The first silo, the transaction silo T, has a single party (e.g., owner of the first database 101) that stores information about financial transactions, such as wire transfers between bank accounts. Its features include country, currency, ordering account, beneficiary account, etc. The second silo, the account silo A, maintains data about the accounts involved in these transactions. Silo A comprises K>1 parties (e.g., the owners of the second and third databases 102, 103). Each party (account) stores information for a disjoint subset of accounts, such as account identifiers, flags, and addresses. A one-to-many relationship exists between transactions and accounts, each transaction linking to two accounts, a sender and a receiver. Additionally, there is a one-to-many relationship between accounts and transactions; a single account may participate in multiple transactions, either as a sender or a receiver. Since the transaction party holds the training labels, it also acts as the active party that coordinates the training process. In this role, the transaction party receives embeddings from both the transaction and account silos, performs the final fusion computation, updates the model parameters, and sends gradients back to each party. The labels identify a transaction as ‘1’ if it is fraudulent and ‘0’ otherwise.

In this example embodiment, an FL solution is provided that enables the parties to collaboratively train a model to classify anomalous transactions. X_{T} denotes the dataset consisting of the N transactions held by silo T, and we let X_{A} denote the dataset of accounts held by silo A. Each transaction sample x∈X_{T} corresponds to two samples in X_{A}, a sender account xₛ and a receiver account xᵣ. These account samples are held by different account parties in silo A. Each transaction sample x∈X_{T} also has a label y. We assume that the labels are securely maintained by the transaction party and are protected from any access by the account parties. Let y denote the set of all labels.

In this embodiment, the goal is to train an ML model over the training data X_{A}, X_{T}, and labels y while protecting the privacy of the training data and labels. In this example embodiment, the model consists of three components: (1) a transaction model that accepts a transaction sample as input and produces a transaction embedding; (2) an account model that accepts an account sample as input and produces an account embedding, and (3) a fusion model that combines a transaction embedding, a sender account embedding, and a receiver account embedding to produce a prediction. It will be understood that various types of models may be used: simple, such as linear models, or more complex, such as neural networks.

In this embodiment, the transaction party in T is responsible for training the transaction model parameters B_{T}. In this embodiment, the account parties in A are responsible for training the account model B_{A}. In this embodiment, each account party holds a copy of the account model and collaborates to update its parameters. In this embodiment, the fusion model BF is trained by the transaction party. An illustration of the data and model architecture is shown in FIG. 1. In other embodiments, the parties utilize a trusted third party (sometimes referred to as an active party) to handle training the fusion model.

Let Θ denote the set of all model parameters. Let h_{A}(θ_{A}, xt) represent the account model as a function that produces an embedding from the account xa, and let h_{T}(θ_{T},xt) represent the transaction model as a function that produces an embedding from the transaction xₜ. We assume each embedding is of length P. To train the entire model, the parties collaborate to minimize the following loss function

$$ℒ ( ⊖ ; {x}_{T} , {X}_{A} , y ) = {\sum }_{{x}_{t} ∈ {X}_{T}} ℓ ( {θ}_{F} , {h}_{T} ( {θ}_{T} ; {x}_{t} ) + {h}_{A} ( {θ}_{A} , {x}_{s} ) + {h}_{A} ( {θ}_{A} ; {x}_{r} ) ; {y}_{t} )$$

where [symbol] (·) is the loss for a single transaction (xₜ, [symbol] ₜ) with sender account xᵣ and receiver account xᵣ.

In this embodiment, the goal is to provide provable privacy protection to the training data X_{T} and X_{A} across the parties throughout the execution of the training algorithm. Specifically, the details of account features from leaking to the transaction party or other account parties should be protected. The transaction features should also be protected from leaking to the account parties. The labels y should also be protected from being inferred by account parties.

In this embodiment, it is assumed that the parties are “honest but curious”: they comply with the training protocol but might seek to deduce others' data from information exchanged during the algorithm's execution. It is also assumed that there is no collusion between parties and that communication is secure, so there are no man-in-the-middle attacks.

The following pseudocode provides an embodiment of an algorithm for training a model according to this embodiment:

Notation: TP = Transaction Party, AP = Account Party

```
$1 : Initialize : {Θ}^{0} = [ {θ}_{T}^{0} , {θ}_{A}^{0} , {θ}_{F}^{0} ]$
  2: for t ← 0, . . . , Q - 1 do
  3: Sample minibatch [symbol]  from (X_{T}, y)
  4: for each sample (xₜ, xᵣ, xₛ) ∈ [symbol]  do
  5: /* Generate embedding for the transaction, sender
          account, and receiver account */
  $6 : {e}_{i} ← {h}_{T} ( {θ}_{T}^{t} ; {x}_{t} )$
  $7 : {e}_{s} ← {h}_{A} ( {θ}_{A}^{t} ; {x}_{s} )$
  $8 : {e}_{r} ← {h}_{A} ( {θ}_{A}^{t} ; {x}_{r} )$
  9: end for
10: /* Securely sum embeddings via PBM and MPC */
11: ê ← SECURESUM(eₜ, eₛ, eᵣ, b, β)
12: /* TP updates fusion model parameters */
$13 : {θ}_{F}^{t + 1} ← {θ}_{F}^{t} - η D ( {θ}_{F}^{t} , \hat{e} )$
14: /* Updates transaction model parameters */
$15 : {θ}_{T}^{t + 1} ← {θ}_{T}^{t} - {η}^{t} D ( {θ}_{T}^{t} , {∇}_{h} {ℒ}_{{ℬ}^{t}} )$
16: /* TP computes protected gradients for each AP */
$17 : {∇}_{h} {\hat{ℒ}}_{{ℬ}_{ι}^{t}} ← LP ( y , p )$
18: for each AP i in parallel do
19: /* AP i computes quantized clipped gradient */
$20 : {g}_{i} ← D ( {θ}_{{A}_{i}}^{t} , {∇}_{h} {\hat{ℒ}}_{{ℬ}_{ι}^{t}} )$
21: qᵢ ← PBM(Clip (gᵢ, k), b′β′)
22: end for
23: /* At AP1: aggregate via MPC */
$24 : {\hat{q}}^{t} ← {\sum }_{i = 1}^{K} {\tilde{g}}_{i}^{t}$
$25 : {\tilde{g}}^{t} ← \frac{1}{{β}^{′} {b}^{′}} ( {\hat{q}}^{t} - \frac{bK}{2} )$
26: AP1 → send \tilde{g}^{ι}to all other APs
27: for each AP i in parallel do
28: /* AP i updates its model */
$29 : {θ}_{{A}_{ι}}^{t + 1} ← {θ}_{{A}_{ι}}^{t} - \frac{η}{K} {\tilde{g}}^{t}$
30: end for
31: end for
```

First, the model parameters and

$${θ}_{T}^{0} , {θ}_{A}^{0} , and {θ}_{F}^{0}$$

are initialized (line 1). Note that each account party in Silo A holds an identical copy of

$${θ}_{A}^{0}$$

We denote these copies by

$${θ}_{{A}_{1}}^{0} , … {θ}_{{A}_{K}}^{0} .$$

The algorithm runs for [symbol] iterations until a desired convergence criterion is met (line 2). In each iteration, a minibatch of transaction sample IDs, denoted by [symbol] ^{t}, is selected from (X_{T}, y) (line 3). For each transaction i∈ [symbol] , the transaction party generates an embedding

$${e}_{t}^{i} .$$

The transaction party contacts the sender and receiver accounts and tells them to generate the sender account embedding

$${e}_{s}^{i}$$

and the receiver account embedding

$${e}_{r}^{i}$$

(lines 6-8). The embeddings are then shared with the transaction party (line 11). Sharing the embeddings directly with the transaction party could potentially reveal information about the training data. In this embodiment, standard RDP using PBM and MPC is used to protect the privacy of this information. Each party uses Algorithm 1, shown above, to quantize every component of its respective embedding. The parties compute the component-wise sum of their quantized embeddings using MPC, and this quantized sum q is revealed to the transaction party. Pseudocode for Algorithm 2 is:

Algorithm 2 Secure Embedding Sum

```
  1: function SECURESUM(eₜ, eₛ, eᵣ, b, β, k)
  2: /* Each party quantizes its embedding using PBM */
  3: qₜ ← PBM (eₜ, b, β)
  4: qₛ ← PBM (eₛ, b, β)
  5: qᵣ ← PBM (eᵣ, b, β)
  6: /* TP compute the sum via MPC */
  7: \hat{q} ← qₜ + qₛ + qᵣ
  8: /* TP dequantizes the sum */
  $9 : \hat{e} ← \frac{k}{β b} ( \hat{q} - \frac{3 b}{2} )$
10: return ê
11: end function
```

The transaction party estimates the embedding sum as

$$\frac{K}{β b} ( \hat{q} - \frac{bM}{2} ) ,$$

as discussed above regarding the Poisson Binomial Mechanism. The transaction party then utilizes this sum as an input to the fusion model. The transaction party uses the fusion model to generate the prediction y̅ᵢ for each transaction i∈ [symbol] ^{t}. Subsequently, the transaction party computes the loss and updates the fusion model parameters via a descent step, for example, stochastic gradient descent (SGD) or Adam, with learning rate η (line 13). Additionally, the transaction party computes the partial derivative of the loss function with respect to the transaction embeddings. The transaction party then uses this partial derivative ∇ₕ [symbol] _{B}_{^{t}} to compute the descent step and update the transaction model parameters (line 15). For example, with SGD, the transaction party applies the chain rule to update its model parameters as:

$${θ}_{T}^{t + 1} ← {θ}_{T}^{t} - {η}^{t} {∇}_{{θ}_{t}} {h}_{T} ( {θ}_{T}^{t} ; {x}_{t} ) {∇}_{h} {ℒ}_{{ℬ}^{t}}$$

To protect the privacy of sensitive labels from the account parties, the transaction party applies a randomized response mechanism to the labels in this embodiment using Algorithm 3:

Algorithm 3 Label Privacy

```
  1:function LP(y, p)
  2: for each true label [symbol]  ∈ [symbol]  do
  3: Generate random number r ~ Uniform (0, 1)
  4: ^  ← [symbol]  if r < p else 1 - [symbol]
  5: end for
  6: Recompute loss [symbol]  using labels ŷ
  $7 : Compute {∇}_{h} {\hat{ℒ}}_{{ℬ}_{i}^{t}} w . r . t . account embeddings$
  8: /* Send protected gradients to APs */
  9: for each AP i do
10: Send ∇ₕ [symbol]  to AP i
11: end for
12:end function
```

Specifically, each label [symbol] is transformed into a protected label [symbol] using the randomized mechanism. Using these protected labels [symbol] , the transaction party recomputes the loss and calculates the corresponding partial derivatives with respect to the account embeddings. These protected derivatives, denoted by

$${∇}_{h} {\hat{ℒ}}_{{ℬ}_{i}^{t}} ,$$

are securely sent to the respective account parties (line 17).

Each account party i computes its descent step

$${g}_{i}^{t}$$

using the protected partial derivative from the transaction party (line 20). The account party then clips the components of

$${g}_{i}^{t}$$

to bound them within the range [−k, k] and quantizes the components of

$${g}_{i}^{t}$$

using PBM, with parameters b′ and β′, to generate

$${q}_{i}^{t}$$

(line 21). The parties compute the component-wise sum of their quantized descent steps using MPC; this sum \hat{q}^{t} is revealed to account party 1, which dequantizes it to find the estimated sum \tilde{g}^{t} (lines 23-25). Account party 1 shares \tilde{g}^{t} with all other account parties, and each account updates its model parameters with the noisy average descent step as

$${θ}_{{A}_{i}}^{t + 1} ← {θ}_{i}^{t} - \frac{η}{K} {\tilde{g}}^{t}$$

(lines 26-30).

The privacy parameters p, b, b′, β, and β′ can be chosen to achieve different levels of privacy at the cost of injecting different amounts of noise into the training process.

Although the technology has been described and illustrated with respect to exemplary embodiments thereof, it should be understood by those skilled in the art that the foregoing and various other changes, omissions, and additions may be made therein and thereto, without parting from the spirit and scope of the present invention.

1. A method for training a model configured to detect exceptional data in one or more databases among a plurality of databases, the method comprising:
generating, for each record of a first set of data records in a first database, an embedding to form a first set of embeddings, wherein the first set of data records includes one or more field values in common with both of a second and a third set of data records in a second and third database respectively;
generating, for each record of the second set of data records in the second database, an embedding to form a second set of embeddings, wherein the second set of data records includes one or more data records having one or more field values in common with one or more data records in the first set of data records;
generating, for each record of the third set of data records in the third database, an embedding to form a third set of embeddings, wherein the third set of data records includes one or more data records having one or more field values in common with one or more data records in the first set of data records;
generating, for each set of embeddings, a privacy-protected dataset of the embeddings to form a first, second, and third privacy-protected dataset, respectively;
inputting the first, second, and third privacy-protected datasets to the model to generate a prediction for each of the first set of data records;
computing the result of a loss function with respect to the model parameters for each of the first set of data records;
updating the model parameters based on the loss calculated via a gradient step;
computing an additional loss result with respect to parameters of a first embedding model configured to provide embeddings of the data records in the first database to the model and parameters of a second embedding model configured to provide embeddings of the data records in the second and third databases to the model;
updating the first embedding model parameters based on the additional loss result via a gradient step;
generating a privacy protected additional loss result for the second embedding model; and
updating the second embedding model parameters based on the privacy protected additional loss result.

2. The method of claim 1, wherein the step of generating a privacy-protected dataset of the embeddings to form a first, second, and third privacy-protected dataset, comprises applying local differential privacy noise to each embedding.

3. The method of claim 1, wherein the step of generating a privacy-protected dataset of the embeddings to form a first, second, and third privacy-protected dataset, comprises:
applying differential privacy noise to each embedding; and
using multi-party computation to sum the noisy embeddings.

4. The method of claim 1, wherein each of the first set of data records comprises a sensitive label, and the method further comprises the steps of:
transforming each label into a protected label using a randomized response mechanism; and
computing a second additional loss result with respect to parameters of the second embedding model; and
wherein the step of generating a privacy protected additional loss result for the second embedding model comprises using the second additional loss result and the step of updating the second embedding model parameters is based on the second additional loss result.

5. The method of claim 1, wherein the step of computing an additional loss result comprises computing a partial derivative of the loss function for each embedding in the second set of embeddings and each embedding in the third set of embeddings; and
wherein the step of generating a privacy protected additional loss result for the second embedding model further comprises:
computing a descent step using the partial derivatives for each embedding;
quantizing the components of the descent steps using a Poisson Binomial Mechanism; and
computing a component-wise sum of the quantized descent steps using multi-party computation.

6. The method of claim 5, further comprising dequantizing the component-wise sum to obtain an estimated descent step; and
wherein the step of updating the second embedding model parameters comprises using the estimated descent step.

7. The method of claim 6, wherein the step of updating the second embedding model parameters using the estimated descent step further comprises updating the parameters of copies of the second embedding model, each copy associated with one of the second database and the third database.

8. A non-transitory computer readable medium having instructions stored thereon that, when executed by a computing device, cause the computing device to perform operations comprising:
generating, for each record of a first set of data records in a first database, an embedding to form a first set of embeddings, wherein the first set of data records includes one or more field values in common with both of a second and a third set of data records in a second and third database respectively;
generating, for each record of the second set of data records in the second database, an embedding to form a second set of embeddings, wherein the second set of data records includes one or more data records having one or more field values in common with one or more data records in the first set of data records;
generating, for each record of the third set of data records in the third database, an embedding to form a third set of embeddings, wherein the third set of data records includes one or more data records having one or more field values in common with one or more data records in the first set of data records;
generating, for each set of embeddings, a privacy-protected dataset of the embeddings to form a first, second, and third privacy-protected dataset, respectively;
inputting the first, second, and third privacy-protected datasets to the model to generate a prediction for each of the first set of data records;
computing the result of a loss function with respect to the model parameters for each of the first set of data records;
updating the model parameters based on the loss calculated via a gradient step;
computing an additional loss result with respect to parameters of a first embedding model configured to provide embeddings of the data records in the first database to the model and parameters of a second embedding model configured to provide embeddings of the data records in the second and third databases to the model;
updating the first embedding model parameters based on the additional loss result via a gradient step;
generating a privacy protected additional loss result for the second embedding model; and
updating the second embedding model parameters based on the privacy protected additional loss result.

9. The medium of claim 8, wherein the operation of generating a privacy-protected dataset of the embeddings to form a first, second, and third privacy-protected dataset, comprises applying local differential privacy noise to each embedding.

10. The medium of claim 8, wherein the operation of generating a privacy-protected dataset of the embeddings to form a first, second, and third privacy-protected dataset, comprises:
applying differential privacy noise to each embedding; and
using multi-party computation to sum the noisy embeddings.

11. The medium of claim 8, wherein each of the first set of data records comprises a sensitive label, and the medium further comprises instructions for:
transforming each label into a protected label using a randomized response mechanism; and
computing a second additional loss result with respect to parameters of the second embedding model; and
wherein the operation of generating a privacy protected additional loss result for the second embedding model comprises using the second additional loss result and the operation of updating the second embedding model parameters is based on the second additional loss result.

12. The medium of claim 8, wherein the operation of computing an additional loss result comprises computing a partial derivative of the loss function for each embedding in the second set of embeddings and each embedding in the third set of embeddings; and
wherein the operation of generating a privacy protected additional loss result for the second embedding model further comprises:
computing a descent step using the partial derivatives for each embedding;
quantizing the components of the descent steps using a Poisson Binomial Mechanism; and
computing a component-wise sum of the quantized descent steps using multi-party computation.

13. The medium of claim 12, further comprising instructions for dequantizing the component-wise sum to obtain an estimated descent step; and
wherein the operation of updating the second embedding model parameters comprises using the estimated descent step.

14. The medium of claim 13, wherein the operation of updating the second embedding model parameters using the estimated descent step further comprises updating the parameters of copies of the second embedding model, each copy associated with one of the second database and the third database.

15. A system for training a model configured to detect exceptional data in one or more databases among a plurality of databases, the system comprising:
one or more processors; and
a memory coupled to the one or more processors, the memory storing instructions that, when executed by the one or more processors, cause the system to perform operations comprising:
generating, for each record of a first set of data records in a first database, an embedding to form a first set of embeddings, wherein the first set of data records includes one or more field values in common with both of a second and a third set of data records in a second and third database respectively;
generating, for each record of the second set of data records in the second database, an embedding to form a second set of embeddings, wherein the second set of data records includes one or more data records having one or more field values in common with one or more data records in the first set of data records;
generating, for each record of the third set of data records in the third database, an embedding to form a third set of embeddings, wherein the third set of data records includes one or more data records having one or more field values in common with one or more data records in the first set of data records;
generating, for each set of embeddings, a privacy-protected dataset of the embeddings to form a first, second, and third privacy-protected dataset, respectively;
inputting the first, second, and third privacy-protected datasets to the model to generate a prediction for each of the first set of data records;
computing the result of a loss function with respect to the model parameters for each of the first set of data records;
updating the model parameters based on the loss calculated via a gradient step;
computing an additional loss result with respect to parameters of a first embedding model configured to provide embeddings of the data records in the first database to the model and parameters of a second embedding model configured to provide embeddings of the data records in the second and third databases to the model;
updating the first embedding model parameters based on the additional loss result via a gradient step;
generating a privacy protected additional loss result for the second embedding model; and
updating the second embedding model parameters based on the privacy protected additional loss result.

16. The system of claim 15, wherein the operation of generating a privacy-protected dataset of the embeddings to form a first, second, and third privacy-protected dataset, comprises applying local differential privacy noise to each embedding.

17. The system of claim 15, wherein the operation of generating a privacy-protected dataset of the embeddings to form a first, second, and third privacy-protected dataset, comprises:
applying differential privacy noise to each embedding; and
using multi-party computation to sum the noisy embeddings.

18. The system of claim 15, wherein each of the first set of data records comprises a sensitive label, and the medium further comprises instructions for:
transforming each label into a protected label using a randomized response mechanism; and
computing a second additional loss result with respect to parameters of the second embedding model; and
wherein the operation of generating a privacy protected additional loss result for the second embedding model comprises using the second additional loss result and the operation of updating the second embedding model parameters is based on the second additional loss result.

19. The system of claim 15, wherein the operation of computing an additional loss result comprises computing a partial derivative of the loss function for each embedding in the second set of embeddings and each embedding in the third set of embeddings; and
wherein the operation of generating a privacy protected additional loss result for the second embedding model further comprises:
computing a descent step using the partial derivatives for each embedding;
quantizing the components of the descent steps using a Poisson Binomial Mechanism; and
computing a component-wise sum of the quantized descent steps using multi-party computation.

20. The system of claim 19, further comprising instructions for dequantizing the component-wise sum to obtain an estimated descent step; and
wherein the operation of updating the second embedding model parameters comprises using the estimated descent step.

21. The system of claim 20, wherein the operation of updating the second embedding model parameters using the estimated descent step further comprises updating the parameters of copies of the second embedding model, each copy associated with one of the second database and the third database.
